(19) United States
(12) Patent Application Publication
(10) Pub. No.: US 2005/0125288 A1
(43) Pub. Date: Jun. 9, 2005

(54) Methods and system for facilitating sales using a payment-related product

(76) Inventor: Augustine Fou, New York, NY (US)

Correspondence Address: Charles A. Rattner, Esq., 12 Homewood Lane, Darien, CT, 06820-6109, US

(21) Appl. No.: 10/932,738

(22) Filed: Sep. 2, 2004

Related U.S. Application Data
(60) Provisional application No. 60/499,527, filed on Sep. 2, 2003.

(51) Int. Cl. G06F 17/60

(52) U.S. Cl. 705/14

(57) ABSTRACT

Methods and system for facilitating sales using a payment-related product. Payment cards are distributed to consumers. Each card has a universally unique identifier on it. Consumers enter the unique identifier online and receive information further instructions to participate in the marketing program. They then go to offline or online retail stores to make purchases.

### RELATIONSHIP TO OTHER APPLICATIONS

This application claims the benefit under 35 U.S.C. sctn. 19(e) of U.S. Provisional Patent Application No. 60/499,527, entitled METHODS AND DEVICES FOR FACILITATING SALES USING A PAYMENT-RELATED PRODUCT filed Sep. 2, 2003, and incorporated herein by reference in its entirety.

This patent application is related to the co-pending U.S. patent application Ser. No. 10/653,391, entitled METHOD FOR FACILITATING COMMERCIAL PROGRAMS INVOLVING CONSUMER PRODUCTS USING UNIVERSALLY UNIQUE ITEM IDENTIFIERS filed Sep. 2, 2003, and incorporated herein by reference in its entirety.

### FIELD OF THE INVENTION

The present invention relates generally to payment products, and more specifically to using payment-related products in innovative commercial programs to cause or affect sales.

### BACKGROUND OF THE INVENTION

Visa Buxx and other bank-issued payment cards were created for young customers or other customers who could not get a credit card of their own. These payment cards are usually requested by parents to be given to their children as allowance cards. The parents sign up for the card, enter into a contractual agreement with the issuing bank, and load funds onto the card by way of a credit card or direct debit from their bank account. The balance and transaction history of these cards are also accessible online so that the parents can charge up funds and track transaction history. The problem is that young consumers like their independence and do not like the fact that their parents keep track of their spending in detail.

It is generally known that there are over 500 million credit, debit, general purpose, retail, oil and other payment card accounts in the United States (hereafter called “cards”). Worldwide, the figure is almost 1 billion such cards. Typically, each authorized user of an account is issued a card: a physical plastic object with an embossed account number and cardholder name appearing on its face. Anti-counterfeiting indicia, such as holograms, photographs, ID numbers, or signatures, may also appear on the card to discourage wrongful usage. As a further deterrent to wrongful usage, card issuers have added 3-4 digit numbers to the cards and many retailers, especially online retailers, have started to require these numbers as proof that the customer has the card in-hand. These additional digits are not an effective security mechanism if the card itself is stolen. Due to the rapid proliferation of such payment cards, the security afforded by 16-digit account numbers is rapidly decreasing. In fact, it is also well known that 1) the first 6 digits represent the issuing bank and only the last 10 digits identify the card 2) it is easy to accidentally get someone else's card number by mistyping just a single digit, and 3) algorithms to calculate valid 16-digit account numbers are freely available online and anyone with a computer can generate such numbers easily.

Payment cards used also as rewards for employees, sales persons, and customers. In these cases, employers or marketers charge up funds onto the card for use by their employees, sales persons, or customers. These cards are simply given to the recipient as monetary rewards and are merely convenient alternatives to writing a check or depositing monetary rewards into the recipient's account. Also, once the funds are used up, the cards are no longer of any use and thus create a waste disposal challenge, if sufficient quantities of such cards are distributed.

In many popular marketing programs today, marketers attempt to incentivize certain actions on the part of their consumers by providing discounts on purchases for specific items. It is widely known that the frequency of such “sales” not only cheapen the perceived value of an item but also condition the behavior of consumers to buy only when a “sale” is going on. Other marketing programs such as loyalty programs use points or miles to incentivize loyalty without discounting a specific item or giving discounts towards a purchase. However, the challenge with such points systems is that most consumers find it difficult to understand what a point is worth or accumulate enough points in order to use them to get the reward for their purchases; therefore such systems are known to cause only a small lift in sales or increase in loyalty when deployed.

Finally, current bank and network policies do not allow issuing cards without at least one of: a cardmember's personal information, an amount to be loaded onto the card, an account associated with the card with a corresponding amount of available funds or a credit line. Also, technological limitations do not allow dynamic loading or unloading of funds on a payment card based on logical rules or triggers.

### SUMMARY OF THE INVENTION

Accordingly, it is an object of this invention to provide a method and system for causing purchases by randomly loading prize funds onto payment cards for a customer to spend towards a purchase.

It is another object of this invention to provide a method and system for causing purchases by adding bonus funds onto payment cards when a customer adds specified amounts of funds onto the payment card.

It is another object of this invention to provide a method and system for causing purchases by giving a customer a more secure payment card which does not disclose the account number or the customer's personal information during the transaction payment processing and may require the customer authorize the purchase in a second step which is non-contemporaneous to the transaction.

It is another object of this invention to provide a method and system for causing purchases by allowing customers to buy a payment card with cash offline, the universally unique identifier on which can be used to effect payment for an online purchase.

It is another object of this invention to provide a method and system for causing purchases of prepaid services by giving customers a payment card with a universally unique identifier which serves as proof of their payment by cash in a retail store.

It is another object of this invention to provide a method and system for causing purchases by adding bonus funds onto payment cards when a customer adds specified amounts of funds onto the payment card and selecting where they intend to spend the funds; funds are drawn down from a pool of funds funded by participating marketers.

It is another object of this invention to provide a method and system for causing purchases of hard-to-ship items by giving customers a card with a universally unique identifier as proof of their purchase in a retail store; customer subsequently uses the unique identifier and specifies a delivery address to which the item is to be shipped directly, so they do not have to “carry-out” the item from the store.

### BRIEF DESCRIPTION OF THE DRAWINGS

FIG. 1 is a flow chart of the method 10 to cause a purchase by a customer by randomly loading prize funds onto a payment card.

FIG. 2 is a flow chart of the method 20 to cause a purchase by a customer by adding bonus funds onto a payment card based on the funds added by a customer.

FIG. 3 is a flow chart of the method 30 to cause a purchase by a customer by providing a secure payment card which does not disclose sensitive account or customer information during the purchase transaction and requires the customer to confirm the authorization of the purchase in a subsequent step.

FIG. 4 is a flow chart of the method 40 to cause a purchase by a customer by providing a payment card with a universally unique identifier for purchase offline to effect payment for a subsequent online purchase.

FIG. 5 is a flow chart of the method 50 to cause a purchase by a customer by providing a payment card with a universally unique identifier which serves as proof of their payment for prepaid services.

FIG. 6 is a flow chart of the method 60 to cause a purchase by a customer by adding bonus funds onto a payment card from a pool funded by participating marketers when the customer selects where he/she intends to spend the funds.

FIG. 7 is a flow chart of the method 70 to cause a purchase by a customer by giving customers a payment card with a universally unique identifier which they use to subsequently specify a delivery address to which their purchase is to be directly shipped.

### DETAILED DESCRIPTION OF THE INVENTION

A method 10 for increasing sales or purchases in retail locations begins when a plurality of payment cards are distributed to consumers. Each card bears a universally unique identifier, created by combining a pseudo random number and an indication of time. Each card also carries instructions that direct the consumer to a particular website where they participate in the marketing program. Consumers visit the website at their convenience and enter the unique identifier in order to determine how to participate in the program and whether there are any funds loaded on their payment card. Typically they receive a message which instructs them that there is a specific amount of funds on their payment cards and that they must spend these funds at a specific retail location before the expiration of said funds. Different amounts of funds can be loaded onto different payment cards. These funds essentially serve as incentives for the consumer to spend towards a purchase. Different consumers may perceive the different amounts of funds as incentives to a greater or lesser extent and therefore they may or may not take action as a result of such incentive. Whether the consumer takes action or not as a result of the funds loaded onto their card is the basis of new consumer insights research about what incentivizes a particular consumer to make a particular purchase.

A method 20 for increasing sales or purchases in retail locations begins when a plurality of payment cards are distributed to consumers. Each card bears a universally unique identifier, created by combining a pseudo random number and an indication of time. Each card also carries instructions that direct the consumer to a particular website where they participate in the marketing programs. Consumers visit the website at any time at their convenience and enter the unique identifier in order to learn how to participate in the marketing program. Consumers typically receive a message which instructs them that if they were to load up specific amount of funds onto their cards, they would receive bonus funds to spend towards a purchase. For example, if the consumer loads up $50 onto their cards they would receive an extra $10, for a total value of $60 on their payment card. Furthermore a relatively short expiration time is designated in order to and courage spending of the funds in a timely manner towards a purchase.

A method 30 for increasing the security of purchases by consumers using a payment card begins when a plurality of cards are distributed to consumers. Each card bears a universally unique identifier, created by combining a pseudo random number and an indication of time. Consumers come online to check the validity of the UUI and to associate personal information and other payment-related information such as bank, credit or debit account information. At the time of the purchase the consumer presents this card in payment. The retailer swipes the card or enters the UUI into the point-of-sale equipment. The UUI is transmitted to a server which translates it into a corresponding set of instructions to effect a transfer of funds from an account that is owned or controlled by the consumer making the purchase to an account that is owned or controlled by the retailer making the sale. In this way, the consumer's personal and payment-related information are never disclosed to the retailer. This preserves the consumer's privacy which in turn increases comfort level and purchases.

A method of 40 for causing purchases by allowing customers to buy a payment card with cash offline, the universally unique identifier on which can be used to effect payment for an online purchase, begins when a customer buys a card with a universally unique identifier on it. They go online to make a purchase and present the UUI for payment. The online retail website transmits the UUI for validation and receives a message in return specifying the validity of the UUI and the value of funds associated with it. The online retail website then decides to approve or decline the transaction based on the available funds associated with the UUI. If the transaction is approved and completed, the online retail website transmits the UUI and the corresponding transaction amount to receive the specified amount of funds.

A method of 50 for facilitating the transfer of funds from an individual consumer making payment into an account begins when a consumer purchases the card at the retail location with cash. Each card bears a universally unique identifier, created by combining a pseudo random number and an indication of time. Once the consumer completes the purchase they receive said card. Subsequently, they must go online in order to validate the purchase and activate said funds by logging into an account and entering said unique identifier from card. Because said unique identifier is universally unique the exact amount of the purchase is immediately known and the correct amount of funds can be added into the corresponding account. The account can be any bank account or prepaid account, including prepaid telephone or wireless accounts. Alternatively the consumer can use SMS or text messaging on their mobile phones to enter the unique identifier in order to activate the funds.

A method 60 for increasing the effectiveness of a marketing program begins when one or more marketers make payment into a pool of funds. Then a plurality of payment cards is distributed to consumers. Each card bears a universally unique identifier, created by combining a pseudo random number and an indication of time. Each card also carries instructions that direct the consumer to a particular website where they participate in the marketing programs. Consumers visit the website at any time at their convenience and enter the unique identifier in order to learn how to participate in the marketing program. Consumers typically receive a message which instructs them that if they were to load up specific amount of funds onto their cards, they would receive bonus funds to spend towards a purchase. For example, if the consumer loads up $50 onto their cards they would receive an extra $10, for a total value of $60 on their payment card. During the value load process, the consumer must select one of the retail locations, corresponding to one of the marketers participating in the marketing program, where they prefer to spend their funds. Once selected the payment card is fixed so that it can only be spent at the designated retail location. Furthermore a relatively short expiration time is designated in order to and courage spending of the funds in a timely manner towards a purchase.

A method 70 for increasing purchases of hard-to-ship items begins when a customer enters a retail location and peruses products on display. If they are interested in a product, they make payment at the register and receive a card, with a universally unique identifier on it, that represents the item they just purchased. They must then go online and enter the said unique identifier and specify a delivery address to which the item is to be shipped. The identifier, when combined with a purchaser-supplied delivery address, is translated into a set of instructions which not only effect the transfer of funds from an account owned or controlled by the purchaser to and account owned or controlled by the retailer, but also effects the shipment of the item to the purchaser from a regional warehouse. The advantage of this invention is to dramatically lower the cost of retailing products, especially products which are large in size and weight. And it gives the purchaser a more pleasant experience since the item is delivered directly to their destination without their having to bring it with them right after the purchase.

Although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

1. A method and system for causing or affecting a purchase by a third-party in a retail location, comprising: generating a universally unique identifier (UUI) and affixing the UUI to an item.

2. The method of claim 1, the third-party comprising at least one of: a consumer and an agent of the consumer.

3. The method of claim 1, the UUI comprising an alphanumeric string of characters created by combining a pseudo-random number and an indication of time.

4. The method of claim 1, the item including at least one of a payment card; a payment card; a bank card; a credit card; a smart card; an identification card; a photo card; a consumer product; a consumer packaged good; a compact disc; a digital video disk; goods made primarily of paper, namely token, stickers, labels, stamps, vignettes, bands, sheets, covers, cards and sheaths provided with coding means; packaging materials made of synthetic materials or paper; stamping foils; goods made primarily of plastics, namely tokens, stickers, labels, stamps, vignettes, bands, sheets, covers, cards, sheaths and laminating foils provided with coding means; goods made primarily of metal, namely tokens, stickers, labels, stamps, vignettes, bands, sheets, covers, cards and sheaths provided with coding means; goods in the nature of magnetic, optical or electronic carriers of information, namely tokens, stickers, labels, stamps, vignettes, bands, discs, counters, cards and plates provided with coding means; and an indication.

5. The method of claim 4, the indication including at least one of: the UUI, an incentive, and instructions on how to participate in a commercial program.

6. The method of claim 5, the incentive including at least one of: a discount, a prize, funds, a bonus monetary payment, and a reward given to the third-party after the purchase at the retail location.

7. The method of claim 5, the commercial program comprising at least one of: a marketing program, a product recall program, a rebate program, an advertising program, a research program, a sales promotion program, a fraud-prevention program, an anti-counterfeiting program, an item authentication program, a quality assurance program, a coupon program, and a product usage research program.

8. The method of claim 1, further comprising: distributing the item to the third-party.

9. The method of claim 1, further comprising: receiving from the third-party a request for information corresponding to the indication of the item through a network.

10. The method of claim 9, the information including at least one of: the UUI, a validity of the UUI, the indication of the item, the incentive, and instructions on how to participate in the commercial program.

11. The method of claim 1, further comprising: providing the information in reply through a network in accordance with a commercial program associated with the item.

12. The method of claim 1, further comprising: associating the incentive with the item in accordance with the commercial program.

13. The method of claim 1, further comprising: performing research on at least one of, the third party, the incentive, the purchase, the commercial program, and an interrelation among the third party, the incentive, the purchase, and the commercial program.

14. A method and system for causing or affecting a purchase in a retail location, comprising: receiving an item with a universally unique identifier (UUI) thereon and exchanging information corresponding to the UUI with a third-party through a network.

15. The method of claim 14, further comprising: adding funds to the item in accordance with the commercial program.

16. The method of claim 14, further comprising: selecting the retail location in accordance with the commercial program.

17. The method of claim 14, further comprising: making a purchase in the retail location in accordance with the commercial program.

18. A method and system for causing or affecting a sale in a retail location, comprising: creating a commercial program and determining an incentive.

19. The method of claim 19, further comprising at least one of: delivering the incentive to a third-party, causing the delivery of the incentive to the third-party, and paying the incentive to the third-party.

20. The method of claim 19, the third-party including at least one of: the administrator of the commercial program, the consumer, and the agent of the consumer.

21. The method of claim 19, further comprising: receiving a sale or a change to a sale at the retail location in accordance with the commercial program.
